(19) United States
(12) Patent Application Publication
(10) Pub. No.: US 2020/0137243 A1
(43) Pub. Date: Apr. 30, 2020

(54) INFORMATION PROCESSING APPARATUS AND COMPUTER-READABLE STORAGE MEDIUM STORING USER MANAGEMENT PROGRAM IN INFORMATION PROCESSING APPARATUS AND USER MANAGEMENT METHOD IN INFORMATION PROCESSING APPARATUS

(71) Applicant: SHARP KABUSHIKI KAISHA, Osaka (JP)

(72) Inventors: MIKIYA OKADA, Osaka (JP); TAKASHI SAWANO, Osaka (JP)

(21) Appl. No.: 16/601,039

(22) Filed: Oct. 14, 2019

(30) Foreign Application Priority Data
Oct. 29, 2018 (JP) 2018-203293

(51) Int. Cl. H04N 1/00; G06F 21/31; H04N 1/44

(52) U.S. Cl. CPC H04N 1/00514; H04N 1/0048; H04N 1/00474; H04N 2201/0094; G06F 21/31; H04N 1/00432; H04N 1/4413; H04N 1/00421

(57) ABSTRACT

A multifunction machine according to the present invention has a quick login mode for implementing simple authentication. Moreover, a user can set a password as necessary. In such a quick login mode, user information can be registered and edited as necessary. Note that the user information to which the password is attached can be edited under a condition which is entry of the password or an administrator password. On the other hand, the user information to which no password is attached can be edited without condition. This greatly contributes to proper management of the registered user information.

### BACKGROUND OF THE INVENTION

### Field of the Invention

The present invention relates to an information processing apparatus and a user management program and a user management method in the information processing apparatus, and specifically relates to an information processing apparatus including a display device that displays, based on registered user information, an operator corresponding to each user and receiving authentication operation by such a user and a user management program and a user management method in the information processing apparatus.

### Description of the Background Art

One example of the technique of this type in Japanese Unexamined Patent Application Publication No. 2015-7893. According to the technology disclosed in Japanese Unexamined Patent Application Publication No. 2015-7893, in an image processing device as an information processing apparatus, multiple buttons for user selection as operators are displayed at an operation device serving as a display device in, for example, a multifunction machine (a multifunction peripheral: MFP). Each button corresponds to each user based on registered user information. For example, when a button corresponding to a general user without an administrative right is operated, authentication as the general user is performed, and therefore, use of the multifunction machine as the general user is allowed. On the other hand, when a button corresponding to an administrator is operated, an authentication screen for the administrator is displayed. A password for the administrator is input on such an administrator authentication screen. In this manner, authentication as the administrator is performed, and use of the multifunction machine as the administrator is allowed.

In the information processing apparatus requiring authentication as described above, it is preferably configured so that even the general user without the administrative right can optionally register the user information on such a user oneself, considering, for example, improvement of convenience. Moreover, it is preferably configured so that even the general user can set the password for the user information on such a user oneself to ensure security. Note that when excessive user information is registered or the registered user information is left for a long period of time, so-called useless user information is present, and various disadvantages are caused. Thus, it is a key to properly manage the registered user information, including deletion of the useless user information.

For this reason, an object of the present invention is to provide a new information processing apparatus configured so that registered user information can be properly managed and a user management program and a user management method in the information processing apparatus.

### SUMMARY OF THE INVENTION

For accomplishing such an object, the present invention includes first to sixth aspects of the invention. Of these aspects, the first and second aspects of the invention relate to an information processing apparatus. Moreover, the third and fourth aspects of the invention relate to a user management program in the information processing apparatus. The fifth and sixth aspects of the invention relate to a user management method in the information processing apparatus.

The first aspect of the invention relating to the information processing apparatus is based on an assumption that the information processing apparatus includes a display device. The display device described herein displays an operator based on registered user information. The operator is an element for receiving authentication operation by a user, and corresponds to each user. In addition, the first aspect of the invention further includes a delete command receiving device and a deletion device. The delete command receiving device receives a delete command for deleting the user information corresponding to an optional operator. In a case where a user password is attached to the user information according to the delete command, the deletion device deletes the user information under a condition which is entry of the user password or a predetermined administrator password. On the other hand, in a case where no user password is attached to the user information according to the delete command, the deletion device deletes the user information without condition.

Note that in the first aspect of the invention, attachment of the user password to the user information is optional.

Moreover, in the first aspect of the invention, a display control device may be further provided. Such a display control device controls the display form of each operator according to the frequency of use of the information processing apparatus by each user.

In a case where such a display control device is provided, a communication device and a notification device may be further provided. The communication device performs communication with each user-side user device. For example, a personal computer (hereinafter referred to as “PC”) is provided as the user device described herein. Moreover, when the frequency of use of the information processing apparatus by any user falls below a predetermined first frequency, the notification device sends predetermined communication information to the user device for such a user via the communication device.

Moreover, in addition to the communication device and the notification device, a frequency changing device may be further provided. When response information for the notification information is received from the user device as the destination of the notification information via the communication device, the frequency changing device takes the frequency of use of the information processing apparatus by the user of the user device as not falling below the first frequency.

In addition to the frequency changing device or separately from the frequency changing device, a deletion device may be further provided. The deletion device deletes the user information on any user when the frequency of use of the information processing apparatus by such a user falls below a second frequency lower than the first frequency.

Note that the frequency of use of the information processing apparatus by each user is evaluated by, for example, the length of a period in which a state in which the information processing apparatus is not used by such a user is continued, i.e., the length of a non-use period of the information processing apparatus by such a user.

Moreover, the user information may be registrable as necessary, and may be specifically registrable as necessary by each user.

The information processing apparatus described herein is a multifunction machine, for example.

As in the first aspect of the invention, the second aspect of the invention is also based on an assumption that the information processing apparatus includes a display device. That is, the display device displays an operator based on registered user information. Moreover, the operator is an element for receiving authentication operation by a user, and corresponds to each user. In addition, the second aspect of the invention further includes a display control device. The display control device controls the display form of each operator according to the frequency of use of the information processing apparatus by each user.

The user management program in the information processing apparatus according to the third aspect of the invention is based on an assumption that the information processing apparatus includes a display device. The display device described herein displays an operator based on registered user information. The operator is an element for receiving authentication operation by a user, and corresponds to each user. In addition, the third aspect of the invention causes a computer of the information processing apparatus to execute a delete command receiving process and a deletion process. In the delete command receiving process of these processes, a delete command for deleting the user information corresponding to an optional operator is received. Then, in the deletion process, in a case where a user password is attached to the user information according to the delete command, the user information is deleted under a condition which is entry of the user password or a predetermined administrator password. On the other hand, in a case where no user password is attached to the user information according to the delete command, the user information is deleted without condition in the deletion process.

As in the third aspect of the invention, the fourth aspect of the invention is also based on an assumption that the information processing apparatus includes a display device. That is, the display device displays an operator based on registered user information. Moreover, the operator is an element for receiving authentication operation by a user, and corresponds to each user. In addition, the fourth aspect of the invention causes a computer of the information processing apparatus to execute a display control process. In the display control process, the display form of each operator is controlled according to the frequency of use of the information processing apparatus by each user.

The user management method in the information processing apparatus according to the fifth aspect of the invention is based on an assumption that the information processing apparatus includes a display device. The display device described herein displays an operator based on registered user information. The operator is an element for receiving authentication operation by a user, and corresponds to each user. In addition, the fifth aspect of the invention includes a delete command receiving step and a deletion step. At the delete command receiving step of these steps, a delete command for deleting the user information corresponding to an optional operator is received. Then, at the deletion step, in a case where a user password is attached to the user information according to the delete command, the user information is deleted under a condition which is entry of the user password or a predetermined administrator password. On the other hand, in a case where no user password is attached to the user information according to the delete command, the user information is deleted without condition at the deletion step.

As in the fifth aspect of the invention, the sixth invention of the invention is also based on an assumption that the information processing apparatus includes a display device. That is, the display device displays an operator based on registered user information. The operator is an element for receiving authentication operation by a user, and corresponds to each user. In addition, the sixth aspect of the invention includes a display control step. At the display control step, the display form of each operator is controlled according to the frequency of use of the information processing apparatus by each user.

Note that as an application example of the present invention, specifically an application example of the invention relating to the information processing apparatus, a configuration including a second communication device, a confirmation device, and a second display control device is conceivable. Of these, the second communication device performs communication with each user-side user device as in the above-described communication device (a so-called first communication device). The confirmation device confirms, via the second communication device, whether or not each user device is in an operating state. Moreover, based on a confirmation result by the confirmation device, i.e., based on whether or not each user device is in the operating state, the second display control device controls the display form of each operator.

Moreover, as an application example of the invention relating to the user management program in the information processing apparatus, a configuration in which a computer of the information processing apparatus executes a confirmation process and a second display control process is conceivable. Such an application example is based on an assumption that the information processing apparatus includes a communication device. The communication device performs communication with each user-side user device. In addition, in the confirmation process, it is, via the communication device, confirmed whether or not each user device is in an operating state. Then, based on a confirmation result by the confirmation process, the display form of each operator is controlled in the second display control process.

Further, as an application example of the invention relating to the user management method in the information processing apparatus, a configuration including a confirmation step and a second display control step is conceivable. Such an application example is based on an assumption that the information processing apparatus includes a communication device. The communication device performs communication with each user-side user device. In addition, at the confirmation step, it is, via the communication device, confirmed whether or not each user device is in an operating state. Then, based on a confirmation result by the confirmation step, the display form of each operator is controlled at the second display control step.

According to these aspects of the invention, the user information can be properly managed, including appropriate deletion of the registered user information according to, for example, a use situation of the information processing apparatus by each user.

### BRIEF DESCRIPTION OF THE DRAWINGS

FIG. 1 is a block diagram of an electrical configuration of a multifunction machine according to a first embodiment of the present invention.

FIG. 2 is a diagram of one example of a configuration in which the multifunction machine according to the first embodiment is connected to PCs.

FIG. 3 is a view of one example of a quick login screen in the first embodiment.

FIG. 4 is a view of one example of the quick login screen in a user unregistered state in the first embodiment.

FIG. 5 is a view of one example of another state of the quick login screen in the user unregistered state in the first embodiment.

FIG. 6 is a view of one example of a user add/edit screen in the user unregistered state in the first embodiment.

FIG. 7 is a view of one example of the user add/edit screen in a state in which a user registration screen for new registration has been displayed in the first embodiment.

FIG. 8 is a view of one example of the user add/edit screen after user registration in the first embodiment.

FIG. 9 is a view of one example of another state of the user add/edit screen after user registration in the first embodiment.

FIG. 10 is a conceptual diagram of a configuration of a user management table in the first embodiment.

FIG. 11 is a view of one example of the user add/edit screen in a state in which a user registration screen for editing has been displayed in the first embodiment.

FIG. 12 is a view of one example of the user add/edit screen in a state in which a password entry screen has been displayed in the first embodiment.

FIG. 13 is a memory map conceptually illustrating an inner configuration of a random access memory (RAM) of a main storage in the first embodiment.

FIG. 14 is a flowchart of part of the flow of a user management task executed by a central processing unit (CPU) in the first embodiment.

FIG. 15 is a flowchart of the remaining part of the flow of the user management task executed by the CPU in the first embodiment.

FIG. 16 is a view of one example of a quick login screen in a second embodiment of the present invention.

FIG. 17 is a flowchart of the flow of a login management task executed by a CPU in the second embodiment.

FIG. 18 is a flowchart of the flow of a non-use management task executed by the CPU in the second embodiment.

FIG. 19 is a flowchart of the flow of an icon management task executed by the CPU in the second embodiment.

FIG. 20 is a flowchart of the flow of a notification task executed by a CPU in a third embodiment of the present invention.

FIG. 21 is a flowchart of the flow of a login update task executed by a CPU in a fourth embodiment of the present invention.

FIG. 22 is a flowchart of the flow of an automatic deletion task executed by a CPU in a fifth embodiment of the present invention.

FIG. 23 is a flowchart of the flow of a PC interlocking task executed by a CPU in an application example of the present invention.

### DESCRIPTION OF THE PREFERRED EMBODIMENTS

### First Embodiment

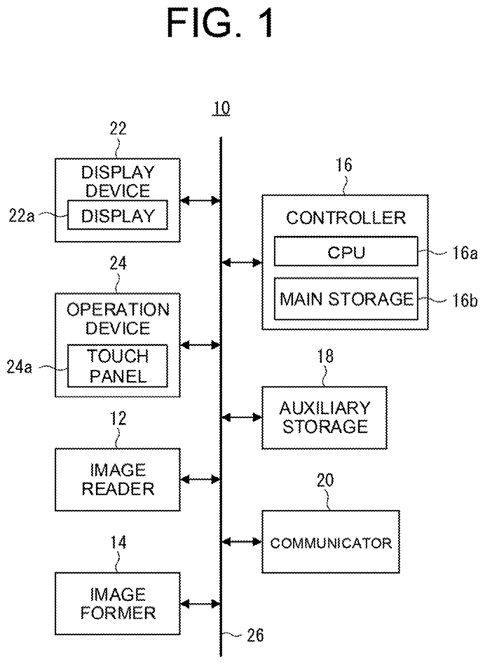

A first embodiment of the present invention will be described by taking a multifunction machine 10 illustrated in FIG. 1 as an example.

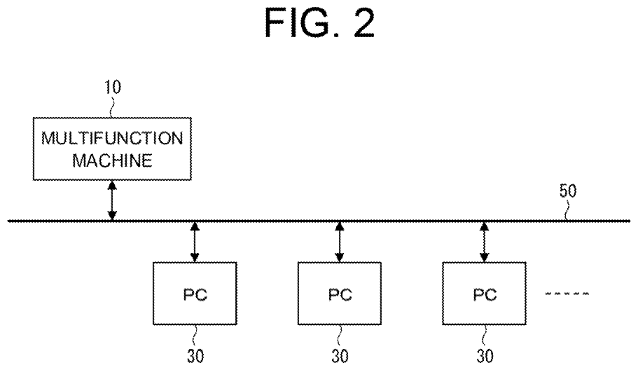

The multifunction machine 10 according to the first embodiment has multiple functions such as a copy function, a printer function, an image scanner function, and a facsimile function. Such a multifunction machine 10 is installed in an office, for example. Mainly in this case, a person working in the office is a user using the multifunction machine 10. In addition, the user of the multifunction machine 10 includes an administrator having an authority to manage the multifunction machine 10. Further, in the office, the multifunction machine 10 and one or more PCs 30 as user devices may be, in some cases, connected to each other via a network 50 as illustrated in FIG. 2. The network 50 described herein is, for example, a local area network (LAN), but is not limited to above. Note that although not illustrated in the figure, the network 50 may be, in some cases, connected to various external devices such as a router and a server, in addition to the PCs 30. Further, the multifunction machine 10 may be connected to a public phone line in some cases.

Referring again to FIG. 1, the multifunction machine 10 includes an image reader 12, an image former 14, a controller 16, an auxiliary storage 18, a communicator 20, a display device 22, and an operation device 24. These are connected to each other via a common bus 26.

The image reader 12 is one example of an image reading device. That is, the image reader 12 performs the image reading processing of reading an image of a not-illustrated document and outputting two-dimensional image data corresponding to the image of the document. Such an image reader 12 includes a not-illustrated document table on which the document is placed. In addition, the image reader 12 includes an image reading section having a not-illustrated light source, not-illustrated multiple mirrors, a not-illustrated imaging lens, a not-illustrated line sensor, etc. Further, the image reader 12 includes a not-illustrated such as drive mechanism configured to move the image reading section. Moreover, the image reader 12 may include a not-illustrated auto document feeder (ADF). The image reader 12 is provided to specifically implement the copy function, the image scanner function, and the facsimile function (a fax sending function).

The image former 14 is one example of an image forming device. That is, the image former 14 performs the image forming processing of forming an image on a sheet-shaped image recording medium such as not-illustrated paper by a well-known electrophotographic method. Such an image former 14 includes a not-illustrated photosensitive drum, a not-illustrated charging device, a not-illustrated exposure device, a not-illustrated developing device, a not-illustrated transfer device, a not-illustrated fixing device, etc. The paper on which the image has been formed by the image forming processing by the image former 14, i.e., a print product, is discharged to a not-illustrated paper discharge tray. Note that the image former 14 may execute not only black-white image forming processing but also color image forming processing. Moreover, the image former 14 is not limited to the electrophotographic method, but may employ an inkjet method, for example. The image former 14 is provided to specifically implement the copy function, the printer function, and the facsimile function (the fax sending function).

The controller 16 is one example of a control device configured to control the entirety of the multifunction machine 10. Therefore, the controller 16 has a central processing unit (CPU) 16a as a control execution device. In addition, the controller 16 has a main storage 16b as a main storage device directly accessible by the CPU 16a. The main storage 16b includes a not-illustrated read only memory (ROM) and a not-illustrated random access memory (RAM), and also includes a rewritable non-volatile memory such as a flash memory. Of these components, the ROM stores a control program (firmware) for controlling operation of the CPU 16a. The RAM forms a work area and a buffer area when the CPU 16a executes processing based on the control program. Moreover, the rewritable non-volatile memory stores data which might be rewritten, such as a later-described user management table 400.

The auxiliary storage 18 is one example of an auxiliary storage device, and includes a not-illustrated hard disk, for example. Moreover, the auxiliary storage 18 may include, in some cases, a rewritable non-volatile memory different from that in the main storage 16b. The auxiliary storage 18 stores, as necessary, various types of data such as the image data output from the image reader 12 and data received via the communicator 20 described subsequently.

The communicator 20 is one example of a communication device connected to the above-described network 50 to perform bidirectional communication processing via the network 50, i.e., communication processing with each external device including each PC 30. Connection between the communicator 20 and the network 50 may be wired or wireless, and the communicator 20 is also connected to the above-described public phone line to perform bidirectional communication processing via the public phone line. Such a communicator 20 is provided to specifically implement the printer function, the image scanner function, and the facsimile function. Note that the image scanner function includes, as extended functions, the functions of sending the image data output from the image reader 12 to the external device such as the server and sending the image data via an electronic mail. The communicator 20 is provided to implement these extended functions.

The display device 22 has a display 22a as one example of a display device. The display 22a is, for example, a liquid crystal display (LCD), but is not limited to above. The display 22a may be an organic electroluminescence (EL) display. Moreover, the display device 22 has, in addition to the display 22a, an optional light emitting element such as a not-illustrated light emitting diode (LED).

The operation device 24 is one example of an operation receiving device configured to receive operation by the user, and specifically has a sheet-shaped touch panel 24a. The touch panel 24a is provided on a display surface of the display 22a. The touch panel 24a is, for example, of a capacitance type, but is not limited to above. Other types such as an electromagnetic induction type, a resistance film type, and an infrared type may be employed. In addition to the touch panel 24a, the operation 24 has an optional hardware switch such as a not-illustrated push button switch.

The multifunction machine 10 according to the first embodiment performs user authentication upon use of the multifunction machine 10.

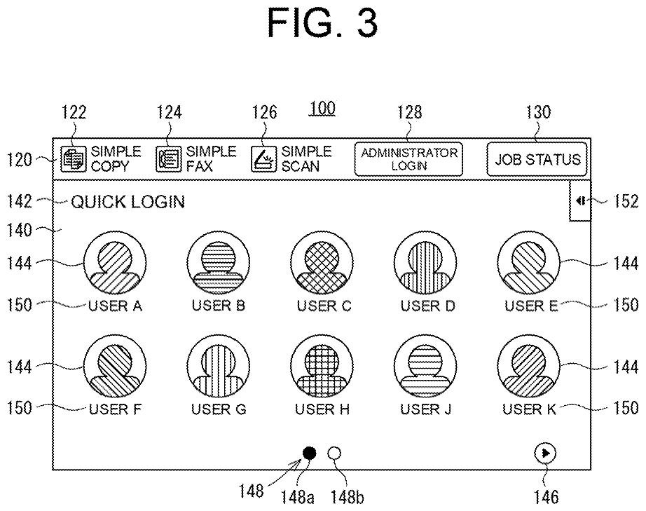

Meanwhile, for reducing the trouble of operation for such user authentication, the multifunction machine 10 has an operation mode called a quick login mode. In such a quick login mode, a quick login screen 100 as illustrated in FIG. 3 is, for example, displayed as a home screen (a basic screen) on the display 22a.

Such a quick login screen 100 includes a strip-shaped display area 120 and a main display area 140. Of these areas, the strip-shaped display area 120 is a horizontally-elongated strip-shaped area covering an upper portion of the quick login screen 100. In such a strip-shaped display area 120, a copy selection button (in a precise sense, a pattern imitating a button) 122 for selecting the copy function, a facsimile selection button 124 for selecting the facsimile function, and an image scanner selection button 126 for selecting the image scanner function are arranged, for example. In addition, in the strip-shaped display area 120, an administrator login button 128 for allowing the administrator to log in and a job status confirmation button 130 for confirming a job status are arranged.

On the other hand, the main display area 140 is an area of the quick login screen 100 other than the strip-shaped display area 120, i.e., a rectangular area covering most of the quick login screen 100. At an upper left portion of the main display area 140, an appropriate character string 142 indicating the title of the quick login screen 100 is arranged. Moreover, in a broad area, which includes a center portion, of the main display area 140 below the character string 142, a user icon 144 as an operator corresponding to each user is arranged. Note that FIG. 3 illustrates an example where ten user icons 144 corresponding to ten users are arranged in five in a lateral direction and two in a longitudinal direction.

Further, at, for example, a lower right portion of the main display area 140, a page switching button 146 for switching the display contents of the main display area 140, i.e., switching a page, is arranged. In addition, at a lower center portion of the main display area 140, a page indicator 148 is arranged. Such a page indicator 148 is an indicator indicating a page being displayed in the main display area 140. For example, the page indicator 148 includes two circular lamps (in a precise sense, patterns imitating lamps) 148a, 148b arranged next to each other. One lamp 148a corresponds to a first page, and the other lamp 148b corresponds to a second page. FIG. 3 illustrates an example where the first page is being displayed, i.e., an example where the lamp 148a corresponding to the first page is ON.

Note that in a case where there are ten users or less, in a precise sense a case where the number of pieces of user information registered in a later-described manner is a number for ten persons or less, the page switching button 146 and the page indicator 148 (two lamps 148a, 148b) are not displayed. Note that in the first embodiment, the user information for up to 20 persons can be registered. Moreover, instead of the page switching button 146 and the page indicator 148, for example, a well-known scroll bar may be provided such that all of the user icons 144 are sequentially displayed. Further, it may be configured such that all of the user icons 144 are displayed at once instead of page switching or scrolling. The display method and arrangement of these user icons 144, the maximum number of pieces of registrable user information, etc. are not limited to the contents described herein.

In addition, a character string 150 indicating a login name as the name of the user corresponding to the user icon 144 is arranged below each user icon 144. Moreover, at an upper right portion of the main display area 140, a tab 152 for opening/closing a later-described action panel 154 is arranged.

On such a quick login screen 100, the user can be authenticated, i.e., can log in, simply by operating (pressing (or also called “tapping”)) the user icon 144 corresponding to the user oneself. According to such simple authentication (or also called “quick authentication”), the trouble of operation according to user authentication can be reduced as described above. However, in such simple authentication, security cannot be ensured. For a user wishing to ensure the security, an optional password can be set as a user password as described later. When the user having set such a password operates the user icon 144 corresponding to the user oneself, a not-illustrated password entry screen is displayed in response to such operation, and therefore, the user can log in by entering the password on the password entry screen.

In addition to above, when the above-described administrator operates the administrator login button 128, a not-illustrated administrator login screen is displayed in response to such operation, and therefore, the administrator can log in as the administrator by entering predetermined information including an administrator password on the administrator login screen. Unlike a so-called general user having logged in by operation of the user icon 144, the administrator having logged in as the administrator can use all functions of the multifunction machine 10 including detailed settings of the multifunction machine 10. In other words, for the general user, available functions among all functions of the multifunction machine 10 are limited. Note that the administrator password is stored (saved) in advance in, for example, the above-described rewritable non-volatile memory forming the main storage 16b. Such an administrator password can be changed as necessary by the administrator.

Such a quick login screen 100 is displayed based on the pre-registered user information. Registration of the user information, i.e., user registration, is performed in the following manner.

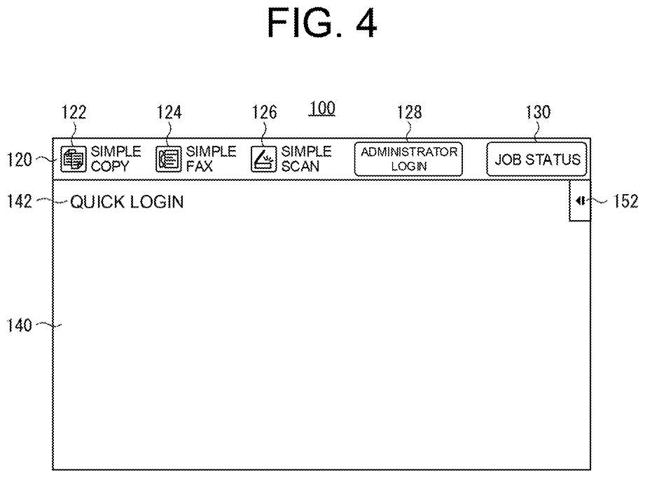

First, when no user information is registered, i.e., when user registration is about to be performed for the first time, the quick login screen 100 as illustrated in FIG. 4 is displayed. On such a quick login screen 100 in a user unregistered state, no user icon 144 and no character string 150 indicating the login name are provided. Moreover, no page switching button 146 and no page indicator 148 are provided.

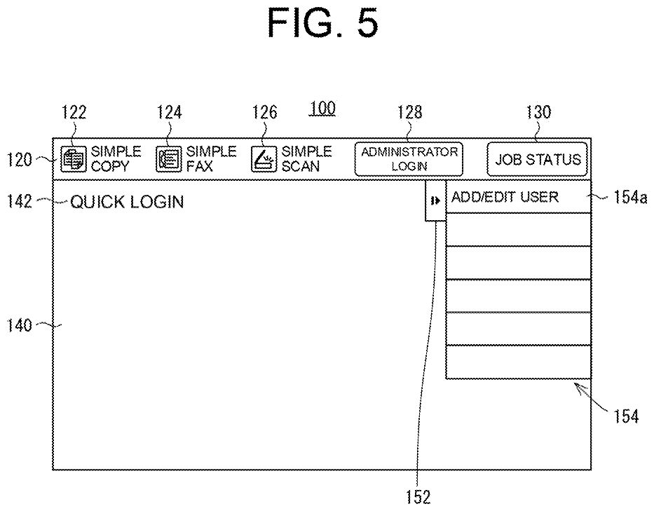

When the tab 152 is operated on the quick login screen 100 in the user unregistered state, such a quick login screen 100 transitions to a state illustrated in FIG. 5. That is, the action panel 154 is displayed to cover part of a right portion of the main display area 140. Such an action panel 154 includes a user add/edit button 154a for displaying a user add/edit screen 200 described next.

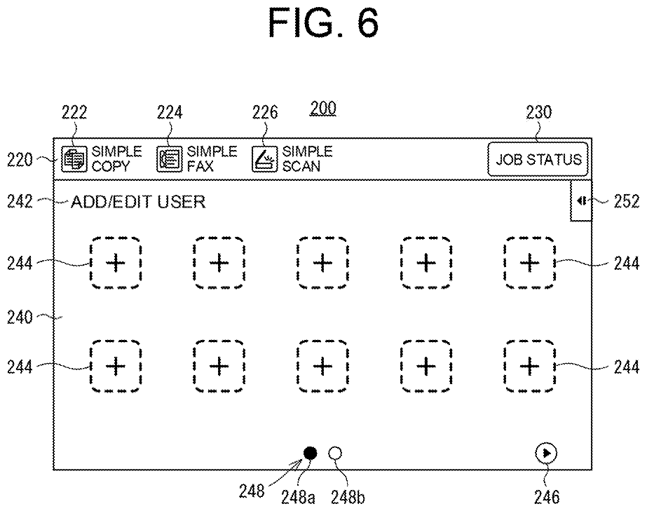

On the quick login screen 100 illustrated in FIG. 5, when the user add/edit button 154a in the action panel 154 is operated, the user add/edit screen 200 illustrated in FIG. 6 is displayed on the display 22a instead of the quick login screen 100. As in the quick login screen 100, such a user add/edit screen 200 also includes a strip-shaped display area 220 and a main display area 240.

In the strip-shaped display area 220 on the user add/edit screen 200, a copy selection button 222, a facsimile selection button 224, and an image scanner selection button 226 similar to those on the quick login screen 100 are arranged. In addition, a job status confirmation button 230 similar to that on the quick login screen 100 is arranged. Note that unlike the quick login screen 100, there is no administrator login button. That is, the administrator operates the administrator login button 128 on the quick login screen 100 to log in as the administrator, and thereafter, proceeds to the user add/edit screen 200 by operation of the user add/edit button 154a on the quick login screen 100.

Meanwhile, at an upper left portion of the main display area 240 on the user add/edit screen 200, an appropriate character string 242 indicating the title of the user add/edit screen 200 is arranged. Moreover, in a broad area, which includes a center portion, of the main display area 240 below the character string 242, for example, ten unregistered icons 244 of appropriate patterns such as patterns including a “+” mark are arranged in five in the lateral direction and two in the longitudinal direction. The number of unregistered icons 244 and arrangement of the unregistered icons 244 follow the number of user icons 144 and arrangement of the user icons 144 on the quick login screen 100 illustrated in FIG. 3, but are not limited to above.

Moreover, at a lower right portion of the main display area 240, a page switching button 246 similar to that on the quick login screen 100 is arranged. In addition, at a lower center portion of the main display area 240, a page indicator 248 similar to that on the quick login screen 100 is arranged. That is, two circular lamps 248a, 248b are arranged next to each other. Note that immediately after transition from the quick login screen 100 to the user add/edit screen 200, a first page of the main display area 240 is displayed. That is, the lamp 248a corresponding to the first page is ON. Further, at an upper right portion of the main display area 240, a tab 252 similar to that on the quick login screen 100 is arranged.

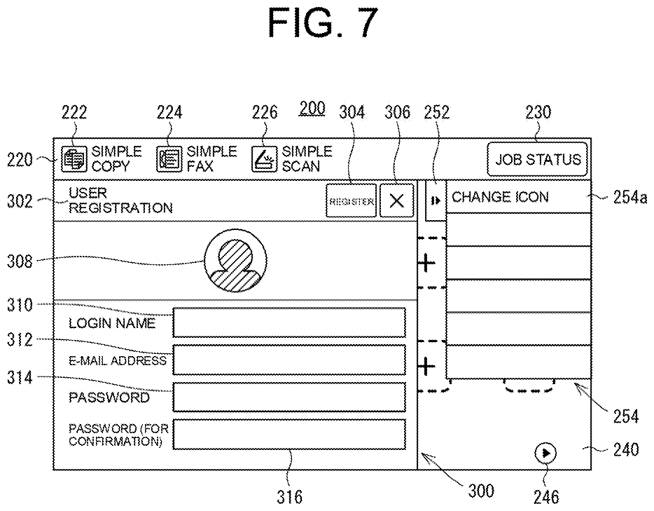

When an optional unregistered icon 244 is operated on the user add/edit screen 200 in the user unregistered state illustrated in FIG. 6, the user add/edit screen 200 transitions to a state illustrated in FIG. 7. That is, a small screen called a user registration screen 300 for new registration is displayed to cover part of the main display area 240 from a left portion to the substantially center portion thereof.

At an upper left portion of the user registration screen 300 for new registration, an appropriate character string 302 indicating the title of the user registration screen 300 is arranged. In addition, at an upper right portion of the user registration screen 300 for new registration, a registration button 304 for setting registration contents of the user registration screen 300 and a close button 306 (with an “x” mark) for closing the user registration screen 300 are arranged next to each other. Moreover, an icon image 308 as an original drawing of the user icon 144 is arranged below these buttons. Further, multiple fields such as four fields 310, 312, 314, and 316 are vertically arranged in line below the icon image 308. The uppermost field 310 is a field for entering the login name of the user to be registered, and the second field 312 is a field for registering a user's electronic mail (e-mail) address. Moreover, the third field 314 is a field for entering an optional password for the user to be registered, and the lowermost field 316 is a field for re-entering the password for confirmation.

In addition, when the above-described tab 252 is operated, the action panel 254 is displayed. Such an action panel 254 includes an icon change button 254a for changing the icon image 308, i.e., for changing the user icon 144.

On the user registration screen 300 for new registration as illustrated in FIG. 7, when, for example, the icon image 308 is operated, a not-illustrated icon selection screen is displayed. Moreover, in a case where the icon change button 254a in the action panel 254 is operated, the icon selection screen is also displayed. The icon selection screen includes many icon samples. When an optional icon sample is selected (operated) on such an icon selection screen, the icon image 308 corresponding to the selected icon sample is set. That is, the user icon 144 is set. Thereafter, the icon selection screen is closed.

Then, the login name is entered to the uppermost field 310 of the fields 310, 312, 314, 316 as described above, but only entry of the login name to such a filed 310 is required. Entry to the other fields 312, 314, 316, i.e., entry of the electronic mail address and the password, is not required, but is optional. Upon entry to these fields 310, 312, 314, 316, a not-illustrated software keyboard is displayed.

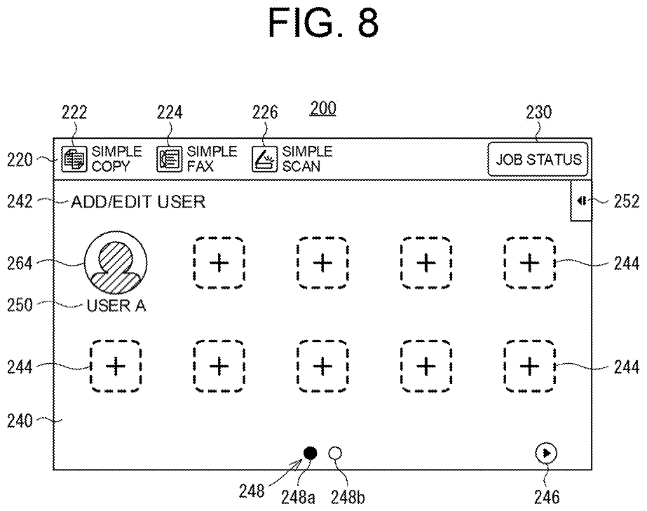

On the user registration screen 300 for new registration, when the registration button 304 is operated with the login name being entered to at least the uppermost field 310, the registration contents including such a login name is set. Thereafter, the user registration screen 300 for new registration is closed. As a result, the user add/edit screen 200 transitions to a state illustrated in FIG. 8. Note that when the registration button 304 is operated without the login name being entered to the uppermost field 310 on the user registration screen 300 for new registration, a not-illustrated small screen called an error message screen is displayed for a certain period of time (for example, several seconds). Thereafter, a state immediately before operation of the registration button 304 is reproduced. That is, the user registration screen 300 for new registration in a state in which no login name has been entered to the uppermost field 310 is displayed again. In a case where the close button 306 on the user registration screen 300 for new registration is operated, the user registration screen 300 is closed as it is. That is, the state immediately before the user registration screen 300 is displayed is reproduced.

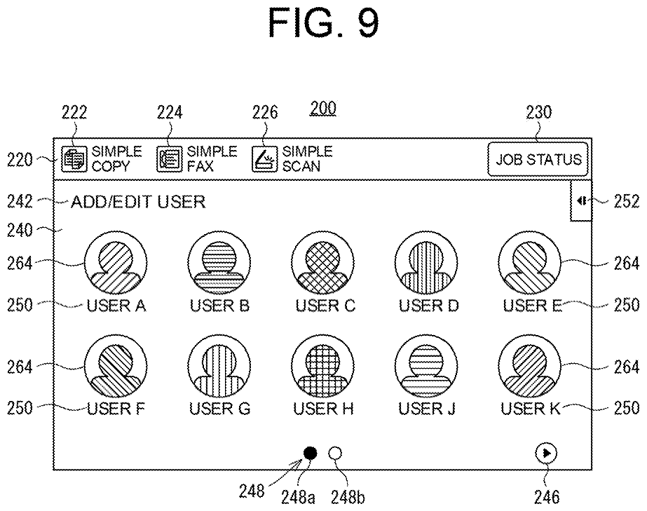

On the user add/edit screen 200 illustrated in FIG. 8, a user icon 264 is, based on the contents registered on the user registration screen 300 for new registration, arranged instead of the unregistered icon 244 operated immediately before the user registration screen 300 is displayed. Note that FIG. 8 illustrates an example where the newly-registered user icon 264 is arranged instead of the unregistered icon 244 at an upper left corner portion of the main display area 240. In addition, a character string 250 indicating the login name of the user is arranged below the user icon 264. The user icon 264 and the character string 250 on the user add/edit screen 200 correspond to the user icon 144 and the character string 150 on the quick login screen 100, i.e., the original forms of the user icon 144 and the character string 150 on the quick login screen 100. In a manner similar to above, other users can be registered as necessary. For example, the user add/edit screen 200 is brought into a state illustrated in FIG. 9 by user registration for 10 persons or more.

Although not illustrated in the figure, when the tab 252 is operated on the user add/edit screen 200 illustrated in FIG. 9, the action panel 254 is displayed. Such an action panel 254 includes a return button for returning to the quick login screen 100. When such a return button is operated, the quick login screen 100 illustrated in FIG. 3 is displayed on the display 22a instead of the user add/edit screen 200. Note that, similarly on the user add/edit screen 200 in the user unregistered state as illustrated in FIG. 6, when the tab 252 is operated, the action panel 254 including the return button is also displayed. Then, when the return button in such an action panel 254 is operated, the quick login screen 100 in the user unregistered state as illustrated in FIG. 4 is displayed on the display 22a instead of the user add/edit screen 200 illustrated in FIG. 6. Further, the above-described hardware switch forming the operation device 24 includes the home button, and by operation of such a home button, the quick login screen 100 is also displayed instead of the user add/edit screen 200.

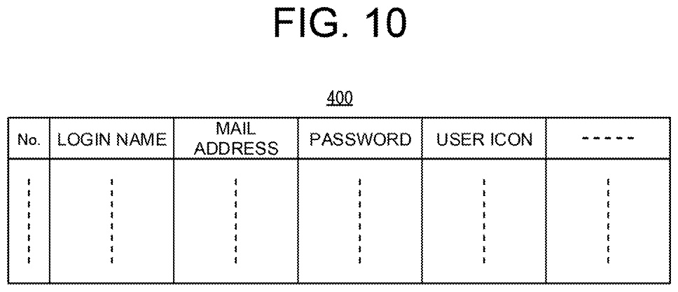

When user registration is performed in this way, the user information regarding such user registration is recorded in the user management table 400 illustrated in FIG. 10. Specifically, for each user, information such as a management number (No.), the login name, the electronic mail address, the password, the user icon (in a precise sense, an icon sample number) is recorded as such user information. Note that the electronic mail address and the password are recorded in the user management table 400 only in a case where the electronic mail address and the password are entered on the user registration screen 300 for new registration. The user information for up to 20 persons can be recorded in such a user management table 400. The user management table 400 is stored in the above-described rewritable non-volatile memory forming the main storage 16b.

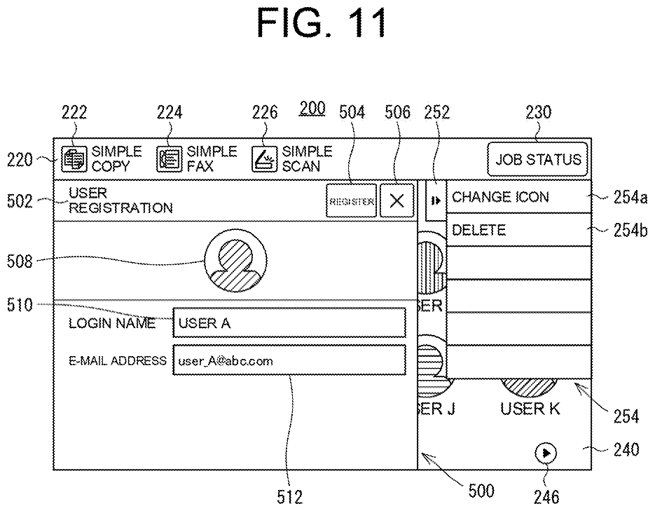

Further, in the first embodiment, registered user information can be edited. For example, it is assumed that an optional user icon 264 is operated on the user add/edit screen 200 illustrated in FIG. 9. In addition, it is assumed that no password is attached (set) to the user information regarding the operated user icon 264. Then, the user add/edit screen 200 transitions to a state illustrated in FIG. 11. That is, a small screen called a user registration screen for editing 500 is displayed to cover part of the main display area 240 from the left portion to the substantially center portion thereof. Note that FIG. 11 illustrates the state in a case where the user icon 264 corresponding to a “user A” is operated on the user add/edit screen 200 illustrated in FIG. 9. On the user registration screen for editing 500, an appropriate character string 502 indicating the title of the user registration screen 500 is arranged at an upper left portion as in the user registration screen 300 for new registration. In addition, at an upper right portion of the user registration screen for editing 500, a registration button 504 for setting registration (editing) contents of the user registration screen 500 and a close button 506 for closing the user registration screen 500 are arranged next to each other. Moreover, an icon image 508 is arranged below these buttons. Further, two fields 510, 512 are vertically arranged in line below the icon image 508. The upper field 510 is a field for editing the login name, and the lower field 512 is a field for editing the electronic mail address.

In addition, when the tab 252 is operated, the action panel 254 is displayed. Note that a delete button 254b for deleting the user information targeted for editing, i.e., for deleting the registered user, is, in addition to the icon change button 254a, included in the action panel 254 when the user registration screen for editing 500 is displayed.

On the user registration screen for editing 500 as illustrated in FIG. 11, when, for example, the icon image 508 is operated, the above-described icon selection screen is displayed. Moreover, in a case where the icon change button 254a in the action panel 254 is operated, the icon selection screen is also displayed. With such an icon selection screen, the icon image 508 can be edited (changed). That is, the user icon 144 can be edited. In the upper field 510, the login name can be edited as necessary. In the lower field 512, the electronic mail address can be edited as necessary. Upon editing of the login name and the electronic mail address, the above-described software keyboard is displayed. Note that the password cannot be edited.

On the user registration screen for editing 500, when the registration button 504 is operated after appropriate editing, the edited contents are set, i.e., recording contents of the user management table 400 are updated. Then, the user registration screen for editing 500 is closed. As a result, the user add/edit screen 200 transitions to a state based on the updated recording contents of the user management table 400. Note that when the registration button 504 is, for example, operated in a state in which no login name is entered to the upper field 510 on the user registration screen for editing 500, an error message screen similar to that described above is displayed for a certain period of time. Thereafter, a state immediately before operation of the registration button 504 is reproduced. That is, the user registration screen for editing 500 in a state in which no login name is entered to the upper field 510 is displayed again. Moreover, in a case where the close button 506 on the user registration screen for editing 500 is operated, such a user registration screen 500 is closed as it is, i.e., a state immediately before the user registration screen 500 is displayed is reproduced. Further, when the delete button 254b in the action panel 254 is operated, the user information targeted for editing is deleted from the user management table 400, i.e., the recording contents of the user management table 400 are updated. Then, the user registration screen for editing 500 is closed. As a result, the user add/edit screen 200 transitions to the state based on the updated recording contents of the user management table 400.

Note that operation of the delete button 254b in the action panel 254 corresponds to one example of a delete command according to the present invention. Moreover, the delete button 254b corresponds to one example of a delete command receiving device according to the present invention.

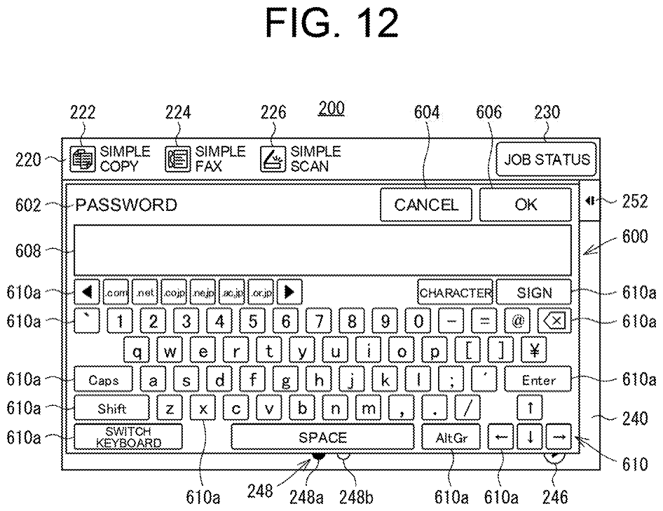

On the other hand, when the password is attached to the user information regarding the user icon 264 operated on the user add/edit screen 200, the user add/edit screen 200 transitions to a state illustrated in FIG. 12. That is, a small screen called a password entry screen 600 slightly smaller than the main display area 240 is displayed to cover the main display area 240.

On such a password entry screen 600, an appropriate character string 602 indicating the title of the password entry screen 600 is arranged at an upper left portion. In addition, at an upper right portion of the password entry screen 600, a cancel button 604 and an OK button 606 are arranged next to each other. Moreover, a horizontally-elongated rectangular password display area 608 is arranged below these buttons. Further, a software keyboard 610 is arranged below the password display area 608. The software keyboard 610 includes multiple appropriate operation keys 610a.

On such a password entry screen 600, the same password as that upon registration is entered by operation of the software keyboard 610 (the appropriate operation keys 610a). The entered password is displayed in the password display area 608. Thereafter, when the OK button 606 is operated, verification between the entered password and the registered password is performed. Then, in a case where both passwords are verified, i.e., both passwords are matched, the above-described user registration screen for editing 500 is displayed instead of the password entry screen 600. This allows editing of the user information in a manner similar to that described with reference to FIG. 11. Note that as described above, the password cannot be edited.

Note that in a case where both passwords are not verified, i.e., in a case where both passwords are not matched, a small screen called a not-illustrated warning screen is displayed for a certain period of time (for example, several seconds). Thereafter, the password entry screen 600 is closed, and a state immediately before the password entry screen 600 is displayed is reproduced. For example, in a case where the multifunction machine 10 includes a voice outputter having a not-illustrated speaker, an appropriate warning message indicating, via voice, that the passwords are not verified may be output in addition to display of the warning screen or instead of display of the warning screen.

Further, in a case where the cancel button 604 on the password entry screen 600 is operated, password entry operation on the password entry screen 600 is cancelled. That is, the password entry screen 600 is closed, and the state immediately before the password entry screen 600 is displayed is reproduced.

On such a password entry screen 600, the user registration screen for editing 500 is also displayed by entry of the above-described administrator password instead of the user password. That is, editing of the user information to which the password is attached can be performed. That is, the user information to which the password is attached can be edited not only by the user oneself having set the password, but also by the administrator with an administrative right.

As described above, according to the first embodiment, the registered user information can be edited as necessary. Upon such editing, entry of the password or entry of the administrator password is set as a condition for the user information to which the password is attached. On the other hand, for the user information to which no password is attached, such user information can be edited without condition. This is extremely useful for properly managing the user information.

For example, if excessive user information is registered or the registered user information is left for a long period of time, so-called useless user information is present, leading to various disadvantages. Thus, the useless user information is preferably deleted as necessary. On the other hand, for the user information to which the password is attached, entry of such a password or entry of the administrator password is preferably set as the condition upon editing including deletion. The first embodiment is extremely suitable for meeting these requirements.

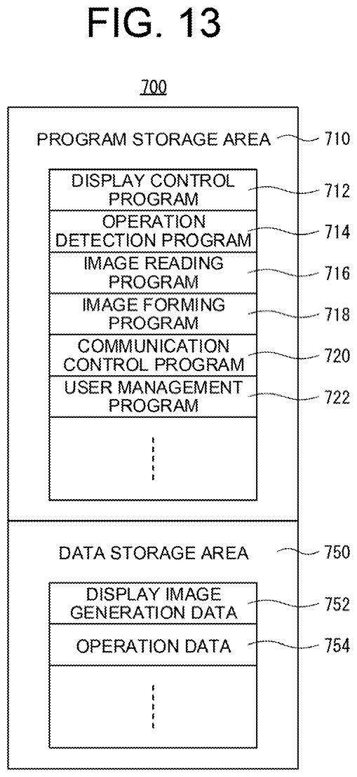

FIG. 13 illustrates a memory map 700 conceptually illustrating an inner configuration of the RAM of the main storage 16b.

As illustrated in such a memory map 700, the RAM has a program storage area 710 and a data storage area 750. Of these areas, the program storage area 710 stores the above-described control program. Specifically, the control program includes a display control program 712, an operation detection program 714, an image reading program 716, an image forming program 718, a communication control program 720, a user management program 722, etc.

The display control program 712 is a program for generating display screen data necessary for displaying various screens such as the quick login screen 100 and the user add/edit screen 200 on the display 22a. The operation detection program 714 is a program for detecting an operation state of the touch panel 24a. The image reading program 716 is a program for controlling the image reader 12. The image forming program 718 is a program for controlling the image former 14. The communication control program 720 is a program for controlling the communicator 20. Moreover, the user management program 722 is a program for causing the CPU 16a to execute a later-described user management task.

On the other hand, various types of data are stored in the data storage area 750. Examples of these various types of data include display image generation data 752 and operation data 754.

The display image generation data 752 is data used to generate the display screen data based on the above-described display control program 712, such as polygon data and text data. Moreover, the operation data 754 is data indicating an operation state of the touch panel 24a, and specifically, is time-series data indicating a user's touch position (coordinates) of the touch panel 24a.

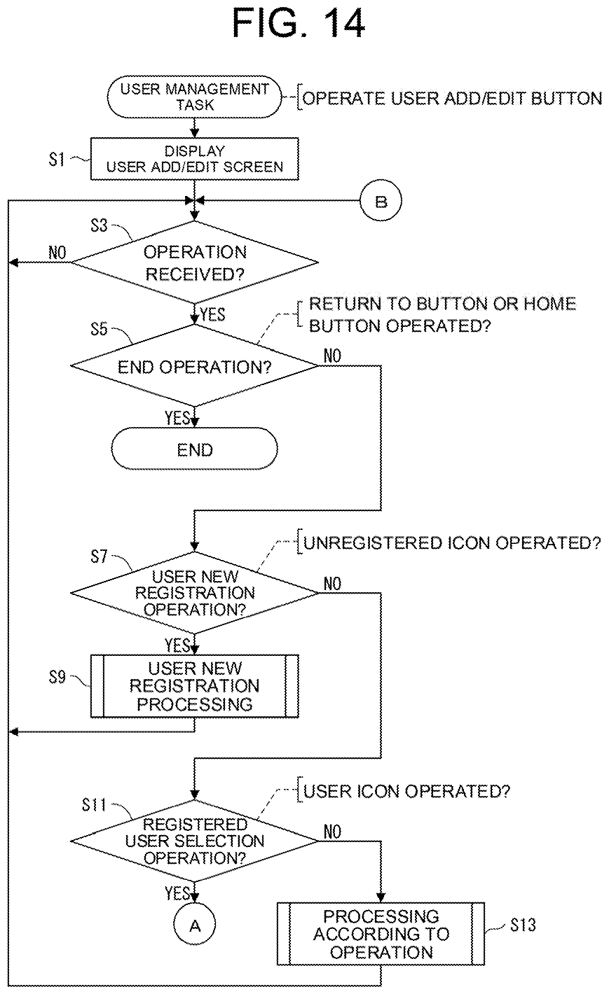

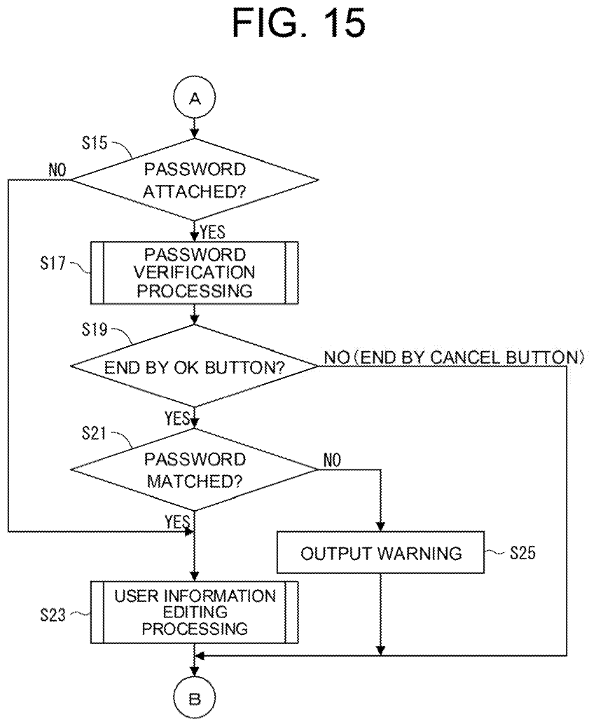

As described above, according to the first embodiment, the registered user information can be properly managed. For implementing such management, the CPU 16a executes the user management task according to the above-described (FIG. 13) user management program 722. The flow of such a user management task is illustrated in FIGS. 14 and 15. Note that the CPU 16a executes such a user management task in response to pressing of the user add/edit button 154a in the action panel 154 on the quick login screen 100.

According to such a user management task, the CPU 16a first displays the user add/edit screen 200 on the display 22a at a step S1. The display contents of the user add/edit screen 200 are based on the recording contents of the user management table 400. Then, the CPU16a proceeds the processing to a step S3.

At the step S3, the CPU 16a waits for reception of some kind of operation by the operation device 24 including the touch panel 24a (S3: NO). Then, when the operation device 24 receives some kind of operation (S3: YES), the CPU 16a proceeds the processing to a step S5.

At the step S5, the CPU 16a determines whether or not the operation received at the step S3 is end operation. The end operation described herein is operation of the above-described return button provided in the action panel 254 on the user add/edit screen 200 or operation of the above-described home button forming the operation device 24. At the step S5, in a case where the operation received at the step S3 is, for example, the end operation (S5: YES), the CPU 16a ends the user management task. Then, the CPU 16a returns to the quick login mode by execution of not-illustrated another task (a quick login task), and first displays the quick login screen 100 on the display 22a. The displayed quick login screen 100 is based on the recording contents of the user management table 400. On the other hand, in a case where the operation received at the step S3 is not the end operation (S5: NO), the CPU16a proceeds the processing from the step S5 to a step S7.

At the step S7, the CPU 16a determines whether or not the operation received at the step S3 is user new registration operation, i.e., operation of any unregistered icon 244. For example, in a case where the operation received at the step S3 is the user new registration operation (S7: YES), the CPU 16a proceeds the processing to a step S9. On the other hand, in a case where the operation received at the step S3 is not the user new registration operation (S7: NO), the CPU 16a proceeds the processing to a later-described step S11.

At the step S9, the CPU 16a executes user new registration processing. In such user new registration processing, the CPU 16a performs appropriate processing for user new registration, the processing including display of the user registration screen 300 for new registration. After execution of such user new registration processing, the CPU 16a returns the processing to the step S3. At this point, the CPU 16a closes the user registration screen 300 for new registration. Note that although detailed description including illustration is omitted, in a case where the user is newly registered in such user new registration processing, the CPU 16a updates the recording contents of the user management table 400 and re-displays the user add/edit screen 200 based on the updated recording contents of the user management table 400.

At the step S11, the CPU 16a determines whether or not the operation received at the step S3 as described above is the operation of selecting the registered user, i.e., operation of any user icon 264. For example, in a case where the operation received at the step S3 is the operation of selecting the registered user (S11: YES), the CPU 16a proceeds the processing to a later-described step S15. On the other hand, in a case where the operation received at the step S3 is not the operation of selecting the registered user (S11: NO), the CPU 16a proceeds the processing to a step S13.

At the step S13, the CPU 16a executes processing corresponding to the operation received at the step S3. The processing at the step S13 includes, for example, page switching corresponding to operation of the page switching button 246 on the user add/edit screen 200 and opening/closing of the action panel 254 corresponding to operation of the tab 252. After execution of the step S13, the CPU 16a returns the processing to the step S3.

At the step S15, the CPU 16a determines whether or not the password is attached to the user information regarding the user icon 264 operated at the above-described step S3, i.e., the user information targeted for editing. Such determination is based on the recording contents of the user management table 400. For example, in a case where the password is not attached (S15: NO), the CPU 16a proceeds the processing to a later-described step S23. On the other hand, in a case where the password is attached (S15: YES), CPU 16a proceeds the processing to a step S17.

At the step S17, the CPU 16a executes password verification processing. In such password verification processing, the CPU 16a performs appropriate processing for verifying the password, the processing including display of the password entry screen 600. After execution of such password verification process, specifically in response to operation of the cancel button 604 or the OK button 606 on the password entry screen 600, the CPU 16a proceeds the processing to a step S19. At this point, the CPU 16a closes the password entry screen 600.

At the step S19, the CPU 16a determines whether or not the password verification processing at the step S17 ends by operation of the OK button 606 on the password entry screen 600. For example, in a case where the processing ends by operation of the OK button 606 (S19: YES), the CPU 16a proceeds the processing to a step S21. On the other hand, in a case where the processing does not end by operation of the OK button 606, i.e., the processing ends by operation of the cancel button 604 (S19: NO), the CPU 16a returns the processing to the step S3.

At the step S21, the CPU 16a determines whether or not the passwords have been verified by the password verification processing at the step S17, i.e., whether or not the password entered on the password entry screen 600 and the registered password are matched with each other. For example, in a case where the passwords have been verified (S21: YES), the CPU 16a proceeds the processing to a step S23. On the other hand, in a case where the passwords have not been verified (S21: NO), the CPU 16a proceeds the processing from the step S21 to a later-described step S25.

At the step S23, the CPU 16a executes user information editing processing. In such user information editing processing, the CPU 16a performs appropriate processing for editing the user information targeted for editing, the processing including display of the user registration screen for editing 500. After execution of such user information editing processing, the CPU 16a returns the processing to the step S3. At this point, the CPU 16a closes the user registration screen for editing 500. Note that although detailed description including illustration is omitted, in a case where the user information has been edited (changed) in the user information editing processing, the CPU 16a updates the recording contents of the user management table 400, and re-displays the user add/edit screen 200 based on the updated recording contents of the user management table 400.

On the other hand, at the step S25, the CPU 16a outputs a warning indicating that the passwords are not verified, and specifically, displays the above-described warning screen for the certain period of time. Note that at the step S25, the above-described warning message via voice may be output in addition to display of the warning screen or instead of display of the warning screen. After execution of the step S25, the CPU 16a returns the processing to the step S3.

As described above, according to the first embodiment, simple authentication is employed to reduce user operation, whereas the password is set as necessary to protect the user information. In addition, proper management of the registered user information including deletion of the useless user information can be performed.

Note that it may be configured such that entry of the password set by the user is necessary only upon editing of the user information on such a user, but is not necessary upon login. That is, the password set by the user may be used only for protecting the user information on such a user.

### Second Embodiment

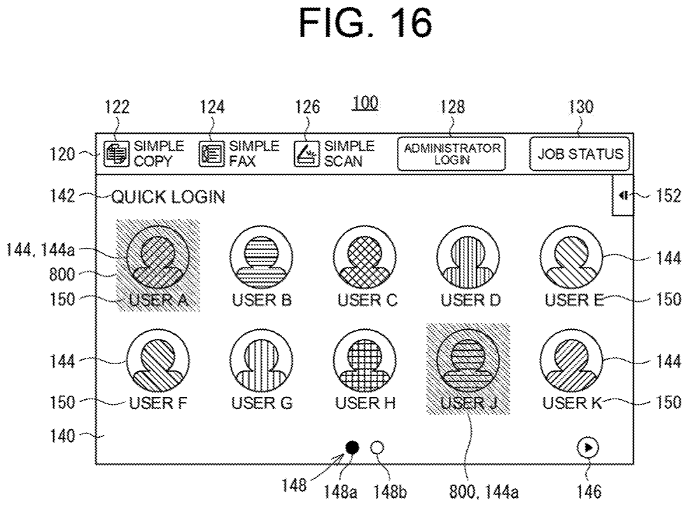

Next, a second embodiment of the present invention will be described with reference to FIGS. 16 to 19.

In the second embodiment, a quick login screen 100 as illustrated in FIG. 16 is displayed, for example. On the quick login screen 100 illustrated in FIG. 16, a user icon 144 (hereinafter sometimes described with a reference numeral “144a”) corresponding to a user not using a multifunction machine 10 for a certain period of time, i.e., a so-called non-use user not logging in the multifunction machine 10 for the certain period of time is displayed in a form different from that of each of other user icons 144. Note that FIG. 16 illustrates an example where a “user A” and a “user J” correspond to non-use users and two user icons 144a corresponding to the “user A” and the “user J” are displayed in a form different from that of each of the other user icons 144, such as in the color of gray. Note that FIG. 16 illustrates that each of two user icons 144a corresponding to the “user A” and the “user J” is provided with a shaded pattern 800 and therefore is displayed in gray. Moreover, the certain period of time as described herein is, for example, 30 days, but can be changed as necessary. Further, although not illustrated in the figure, a user icon 264 (hereinafter sometimes described with a reference numeral “264a”) corresponding to the non-use user not logging in for the certain period of time is, similarly on a user add/edit screen 200, also displayed in a form different from that of each of the other user icons 264, and is specifically displayed in gray.

According to the second embodiment, the presence/absence of the non-use user and the user corresponding to the non-use user can be intuitively grasped from the display form of each user icon 144 on the quick login screen 100. Similarly on the user add/edit screen 200, the presence/absence of the non-use user and the user corresponding to the non-use user can be intuitively grasped from the display form of each user icon 264. This is extremely useful for managing registered user information especially by an administrator. For example, when there is a need to delete any user information, it is an appropriate indication of determining which user information is to be deleted. Thus, the registered user information can be properly and efficiently managed, and a burden on the administrator can be reduced.

Although not illustrated in the figure, a login management program, a non-use management program, and an icon management program are added as the above-described control program in the second embodiment. In addition, the last login time of each user and a non-use appropriateness flag indicating whether or not each user corresponds to the non-use user are added as the user information recorded in a user management table 400. Further, of the user information recorded in the user management table 400, the contents of the non-use appropriateness flag for each user, in a precise sense the contents of the non-use appropriateness flag at a certain time point, are directly copied in a temporary storage register as a temporary storage device. Such a temporary storage register is provided in a rewritable non-volatile memory forming a main storage 16b as described above, for example. In addition, a time manager as a time management device configured to manage current time (year/month/day/hour/minute/second) is provided. Such a time manager includes, for example, a real-time clock (RTC), and is connected to a controller 16 via a bus 26 or is directly connected to the controller 16.

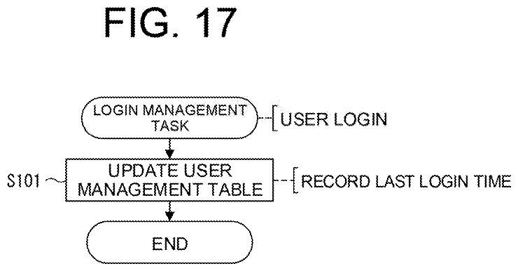

In addition, a CPU 16a executes a login management task according to the above-described login management program. The flow of such a login management task is illustrated in FIG. 17. Note that when any user logs in, i.e., when any user icon 144 on the quick login screen 100 is operated, the CPU 16a executes such a login management task.

According to such a login management task, the CPU 16a records, at a step S101, the login time of the user as the last login time of the user in the user management table 400, i.e., updates recording contents of the user management table 400. Note that the login time of the user is specified based on the current time obtained from the time manager. After execution of the step S101, the CPU 16a ends the login management task.

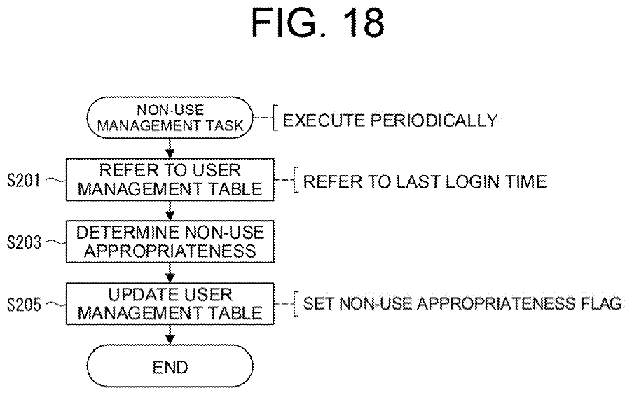

In addition, the CPU 16a executes a non-use management task according to the above-described non-use management program. The flow of such a non-use management task is illustrated in FIG. 18. Note that the CPU 16a repeatedly executes the non-use management task periodically, i.e., at an extremely-shorter time interval than the above-described certain time period of 30 days, such as a relatively-short time interval (cycle) of several seconds to several minutes.

According to such a non-use management task, the CPU 16a first refers to the user management table 400 at a step S201, and specifically refers to the last login time of each user. Then, the CPU 16a proceeds the processing to a step S203.

At the step S203, the CPU 16a determines, for each user, whether or not the above-described certain time period of 30 days has elapsed after the last login time, i.e., whether or not each user corresponds to the non-use user. Upon such determination, the CPU 16a obtains the current time from the time manager, and for each user, calculates a period from the last login time to the current time. Thereafter, the CPU 16a performs such determination. After execution of the step S203, the CPU 16a proceeds the processing to a step S205.

At the step S205, the CPU 16a updates the recording contents of the user management table 400 based on a determination result at the above-described step S203, and specifically sets the non-use appropriateness flag for each user. For example, a value of “1” is set to the non-use appropriateness flag for the user corresponding to the non-use user, and a value of “0” is set to the non-use appropriateness flag for other users. After execution of the step S205, the CPU 16a ends the non-use management task.

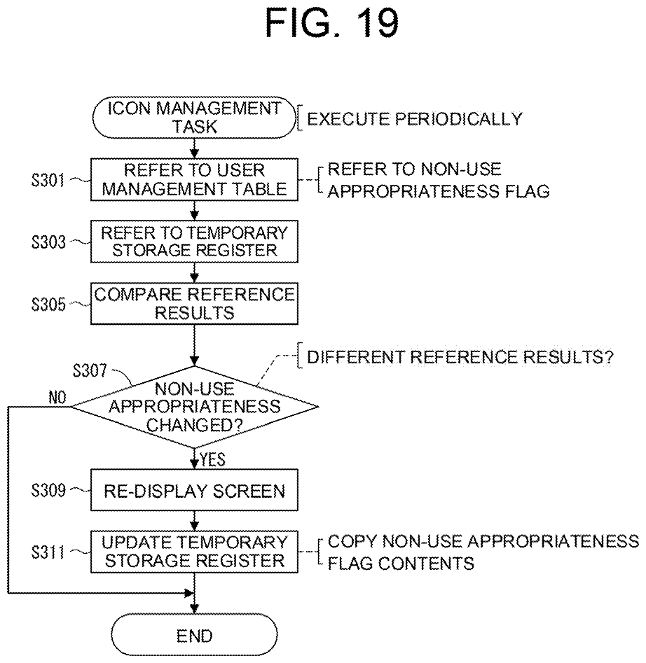

Further, the CPU 16a executes an icon management task according to the above-described icon management program. The flow of such an icon management task is illustrated in FIG. 19. Note that as in the non-use management task, the CPU 16a periodically and repeatedly executes such an icon management task at, for example, a relatively-short time interval of several seconds to several minutes.

According to such an icon management task, the CPU 16a first refers to the user management table 400 at a step S301, and specifically refers to the non-use appropriateness flag for each user. Then, the CPU 16a proceeds the processing to a step S303.

At the step S303, the CPU 16a refers to the above-described temporary storage register. The contents of the non-use appropriateness flag are directly copied in such a temporary storage register. However, at the point of time of first executing the icon management task, such as the point of time immediately after the multifunction machine 10 has been powered ON, a default value is stored. For each user, a value of “0” is stored as the default value. After execution of the step S303, the CPU 16a proceeds the processing to a step S305.

At the step S305, the CPU 16a compares a reference result of the user management table 400 at the step S301 and a reference result of the temporary storage register at the step S303. Thereafter, the CPU 16a proceeds the processing to a step S307.

At the step S307, the CPU 16a determines, based on a comparison result at the step S305, whether or not there is a change in the status of appropriateness of the non-use user. In other words, the CPU 16a determines whether or not the reference result of the user management table 400 at the step S301 and the reference result of the temporary storage register at the step S303 are different from each other. For example, in a case where there is no change in the state of appropriateness of the non-use user (S307: NO), the CPU 16a ends the icon management task as it is. On the other hand, in a case where there is a change in the state of appropriateness of the non-use user, i.e., any user newly corresponds to the non-use user or any user as the non-use user no longer corresponds to the non-use user (S307: YES), the CPU 16a proceeds the processing to a step S309.

At the step S309, the CPU 16a re-displays a currently-displayed screen based on the recording contents of the user management table 400. Thus, in a case where, for example, the quick login screen 100 is being displayed, the user icon 144a corresponding to the user newly corresponding to the non-use user is displayed in gray, or gray display of the user icon 144 corresponding to the user no longer corresponding to the non-use user is canceled. Similarly in a case where the user add/edit screen 200 is being displayed, the user icon 264a corresponding to the user newly corresponding to the non-use user is displayed in gray, or gray display of the user icon 264 corresponding to the user no longer corresponding to the non-use user is canceled. Then, the CPU 16a proceeds the processing to a step S311.

At the step S311, the CPU 16a directly copies the contents of the non-use appropriateness flag recorded in the user management table 400 in the temporary storage register, i.e., updates storage contents of the temporary storage register. After execution of the step S311, the CPU16a ends the icon management task.

As described above, according to the second embodiment, the presence/absence of the non-use user and the user corresponding to the non-use user can be intuitively grasped from the display form of each user icon 144 on the quick login screen 100 or each user icon 264 on the user add/edit screen 200. Thus, the registered user information can be properly and efficiently managed, and the burden on the administrator can be reduced.

Note that in the second embodiment, it is, with reference to the last login time of each user, determined whether or not the above-described certain time period of 30 days has elapsed, but the present invention is not limited to above. For example, it may be, with reference to the last logout time of each user, determined whether or not the certain period of time has elapsed.

Moreover, the user icon 144a, 264a corresponding to the non-use user is displayed in gray, and therefore, is differentiated from the other user icons 144, 264. However, the user icon 144a, 264a is not limited to above. The user icon 144a, 264a corresponding to the non-use user may be provided with an appropriate mark or pattern, or may be displayed in a size or a shape different from those of the other user icons 144, 264. In short, the display form of each user icon 144, 264 is preferably controlled according to the frequency of use of the multifunction machine 10 by each user.

Further, the display form of the user icon 144a, 264a corresponding to the non-use user may be changed according to the length of a period in which each non-use user does not log in the multifunction machine 10, i.e., according to the level (degree) of the frequency of use. For example, according to the level of the frequency of use, the color density of the gray of the user icon 144a, 264a or the color of the user icon 144a, 264a itself may be changed. Alternatively, according to the level of the frequency of use, a different mark or pattern may be attached to the user icon 144a, 264a, or the size or shape of the user icon 144a, 264a itself may be changed.

The display form of each user icon 144, 264 including the user icon 144a, 264a corresponding to the non-use user is controlled by the CPU 16a, and the CPU 16a responsible for such control is one example of a display control device according to the present invention. Moreover, the frequency of use of the multifunction machine 10 by each user is not limited to the elapsed period of time from the last login time of each user, and may be evaluated by another parameter.

The second embodiment may be performed in parallel with (at the same time of) the above-described first embodiment, or may be performed separately from (independently of) the first embodiment.

### Third Embodiment

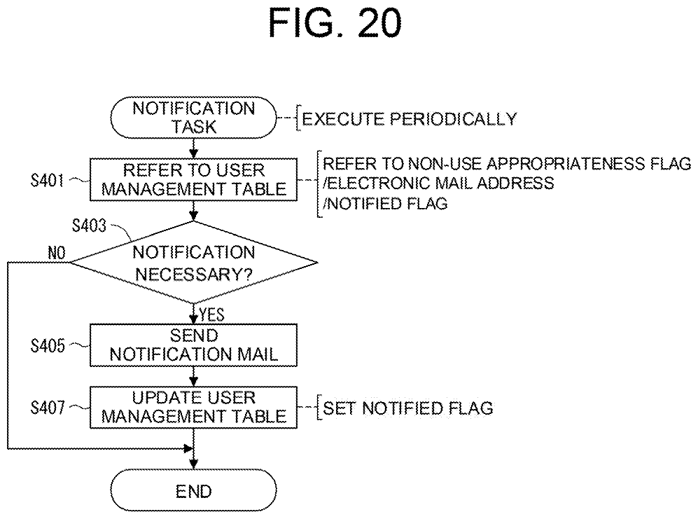

Next, a third embodiment of the present invention will be described with reference to FIG. 20.

The third embodiment is based on the above-described configuration of the second embodiment. Specifically, in the third embodiment, the non-use user in the second embodiment is notified that such a user corresponds to the non-use user. More specifically, in a case where user information on the user corresponding to the non-use user includes an electronic mail address, a notification mail including contents indicating that the user corresponds to the non-use user is sent to such an electronic mail address. Thus, the user having received the notification mail can recognize, from the notification mail, that the user oneself corresponds to the non-use user. Then, the non-use user having received the notification mail logs in, for example, a multifunction machine 10 again so that appropriate action such as the action of preventing the user to correspond to the non-use user or the action of voluntarily deleting the user information corresponding to the user oneself can be taken. This also greatly contributes to proper management of the registered user information.

For this reason, although not illustrated in the figure, a notification program is, in addition to the configuration of the second embodiment, added as the above-described control program in the third embodiment. In addition, a so-called notified flag indicating whether or not the notification mail has been sent to each user is added as the user information recorded in a user management table 400. Note that immediately after the multifunction machine 10 is powered ON, a default value of “0” indicating that the notification mail is not sent to each user yet is set to the notified flag for each user.

Thereafter, a CPU 16a executes a notification task according to the notification program. FIG. 20 illustrates the flow of such a notification task. Note that as in, for example, the above-described non-use management task and the above-described icon management task, the CPU 16a periodically and repeatedly executes such a notification task at a relatively-short time interval of several seconds to several minutes.

According to such a notification task, the CPU 16a first refers to the user management table 400 at a step S401, and specifically refers to the above-described non-use appropriateness flag, the above-described electronic mail address, and the above-described notified flag for each user. Then, the CPU 16a proceeds the processing to a step S403.

At the step S403, the CPU 16a determines, based on a reference result at the step S401, whether or not it is necessary to send the notification mail, i.e., whether or not there is a non-use user to which the notification mail needs to be sent. In other words, the CPU 16a determines, among the non-use users, the presence/absence of the non-use user whose electronic mail address has been registered and to which the notification mail is not sent yet. For example, in a case where it is not necessary to send the notification mail (S403: NO), the CPU 16a ends the notification task as it is. On the other hand, in a case where it is necessary to send the notification mail (S403: YES), the CPU 16a proceeds the processing to a step S405.

At the step S405, the CPU 16a sends the notification email. That is, the CPU 16a sends the notification mail to the electronic mail address of the non-use user whose electronic mail address has been registered and to which the notification mail is not sent yet among the non-use users. Then, the CPU 16a proceeds the processing to a step S407.

At the step S407, the CPU 16a updates recording contents of the user management table 400, and specifically sets a value of “1” to the notified flag for the user as a destination of the notification mail at the step S405. Such a value of “1” for the notified flag indicates that the notification mail has been sent. After execution of the step S407, the CPU 16a ends the notification task.

As described above, according to the third embodiment, the non-use user is notified that such a user corresponds to the non-use user, and specifically, the notification mail is sent to the electronic mail address of the non-use user. This also greatly contributes to proper management of the registered user information.

Note that the notification mail in the third embodiment is one example of notification information according to the present invention. Moreover, the CPU 16a responsible for sending of the notification mail, i.e., the CPU 16a executing the notification task, is one example of a notification device according to the present invention.

Since the third embodiment is based on the above-described configuration of the second embodiment, a user icon 144a, 264a corresponding to the non-use user is also displayed in gray in the third embodiment. That is, the user icon 144a, 264a corresponding to the non-use user is displayed in a form different from those of the other user icons 144, 264.

Note that the third embodiment is not necessarily based on the configuration of the second embodiment. In this case, the user icon 144a, 264a corresponding to the non-use user is not displayed in gray, but is displayed in a form similar to those of the other user icons 144, 264. Meanwhile, notification to the non-use user, i.e., sending of the notification mail, is performed.

### Fourth Embodiment

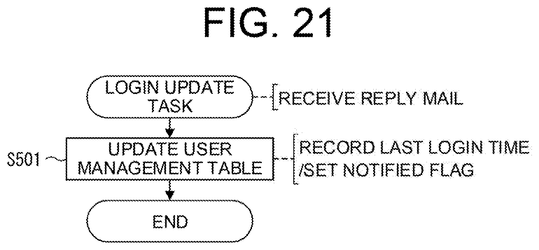

Next, a fourth embodiment of the present invention will be described with reference to FIG. 21.

The fourth embodiment is based on the above-described configuration of the third embodiment. Specifically, in the fourth embodiment, in a case where a reply mail as a response to a notification mail is sent from a non-use user as the destination of the notification mail in the third embodiment, the reception time of such a reply mail is recorded in a user management table 400 as the last login time of the non-use user. Thus, a state similar to a state as if a non-use user as a source of the reply mail has logged in a multifunction machine 10 is formed, and such a user no longer corresponds to the non-use user. Then, gray display of a user icon 144, 264 corresponding to the user no longer corresponding to the non-use user is canceled. That is, the non-use user obtains a result similar to that upon logging in the multifunction machine 10 without directly operating the multifunction machine 10. This greatly contributes to efficient management of registered user information.

For this reason, although not illustrated in the figure, a login update program is, in addition to the configuration of the third embodiment, added as the above-described control program in the fourth embodiment. Moreover, predetermined information indicating that the reply mail is the response to the notification mail, such as a code, is attached to the replay mail as the response to the above-described notification mail. Thereafter, a CPU 16a executes a login update task according to the login update program. FIG. 21 illustrates the flow of such a login update task. Note that the CPU 16a executes the login update task when receiving the replay mail described herein.

According to such a login update task, the CPU 16a updates, at a step S501, recording contents of the user management table 400. Specifically, the CPU 16a records the reception time of the replay mail as the last login time of the non-use user as the source of the replay mail, and resets such last login time. In addition, the CPU 16a sets a value of “0” to a notified flag for the non-use user as the source of the reply mail, and also resets such a notified flag. After execution of the step S501, the CPU 16a ends the login update task.

As described above, according to the fourth embodiment, the non-use user having received the above-described notification mail merely replies to such a notification mail, and in this manner, can obtain a result similar to that obtained upon logging in the multifunction machine 10. This greatly contributes to efficient management of the registered user information.

Note that the reply mail in the fourth embodiment is one example of response information according to the present invention. The CPU 16a executes the login update task such that the state similar to the state when the non-use user as the source of the reply mail described herein has logged in the multifunction machine 10 is formed, and the CPU 16a executing such a login update task is one example of a frequency changing device according to the present invention. Further, the notification mail is sent to the non-use user not logging in for the above-described certain time period of 30 days, and a criterion as a trigger for sending such a notification mail that the non-use user has not logged in for the certain period of time as described herein is one example of a first frequency according to the present invention.

Moreover, in the fourth embodiment, when the above-described reply mail is sent, the reception time of such a reply mail is recorded as the last login time of the non-use user as the source of the reply mail. However, the present invention is not limited to above. For example, appropriate time between actual last login time and the reception time of the reply mail may be recorded as the last login time.

Since the fourth embodiment is based on the configuration of the third embodiment as described above, a user icon 144a, 264a corresponding to the non-use user is also displayed in gray in the fourth embodiment as in the third embodiment, i.e., the second embodiment. That is, the user icon 144a, 264a corresponding to the non-use user is displayed in a form different from those of the other user icons 144, 264.

Note that it may be configured such that the user icon 144a, 264a corresponding to the non-use user is not displayed in gray, but is displayed in the form similar to those of the other user icons 144, 264. That is, it may be configured such that regardless of the display form of each user icon 144, 264, when the above-described reply mail is sent, the last login time of the non-use user as the source of such a reply mail is updated.

### Fifth Embodiment

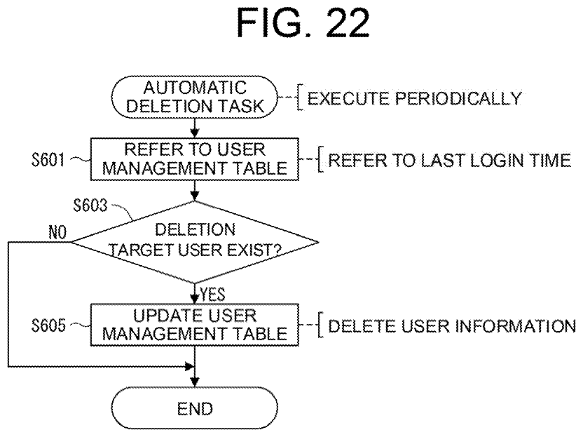

Next, a fifth embodiment of the present invention will be described with reference to FIG. 22.

For example, the fifth embodiment is based on the above-described configuration of the second embodiment. Specifically, in the fifth embodiment, user information on a user not logging in for a further predetermined extension period among the non-use users in the second embodiment is automatically deleted. This also greatly contributes to proper and efficient management of the registered user information, and specifically greatly contributes to reduction in a burden on an administrator. Note that the extension period described herein is, for example, ten days, but can be changed as necessary.

Although not illustrated in the figure, an automatic deletion program is, in addition to the configuration of the second embodiment, added as the above-described control program in the fifth embodiment. Then, a CPU 16a executes an automatic deletion task according to such an automatic deletion program. FIG. 22 illustrates the flow of such an automatic deletion task. Note that as in, for example, the above-described non-use management tank and the above-described icon management tank, the CPU 16a periodically and repeatedly executes such an automatic deletion task at a relatively-short time interval of several seconds to several minutes.

According to such an automatic deletion task, the CPU 16a first refers to a user management table 400 at a step S601, and specifically refers to the last login time of each user. Then, the CPU 16a proceeds the processing to a step S603.

At the step S603, the CPU 16a determines, based on a reference result at the step S601, whether or not user information targeted for deletion is present, i.e., the presence/absence of the user information for which the above-described certain time period of 30 days has elapsed from the last login time and the above-described extension period of ten days has further elapsed. For example, in a case where no user information targeted for deletion is present (S603: NO), the CPU 16a ends the automatic deletion task as it is. In a case where the user information targeted for deletion is present (S603: YES), the CPU 16a proceeds the processing to a step S605.

At the step S605, the CPU 16a deletes the user information targeted for deletion from the user management table 400, i.e., updates recording contents of the user management table. After execution of the step S605, the CPU 16a ends the automatic deletion task.

As described above, according to the fifth embodiment, the user information on the user not logging in for the further predetermined extension period among the non-use users is automatically deleted. This greatly contributes to proper and efficient management of the registered user information, and specifically contributes to reduction in the burden on the administrator.

Note that in the fifth embodiment, the user information on the user not logging in for the further predetermined extension period among the non-use users is automatically deleted, and a criterion as a trigger for deleting such user information on the user not logging in for the extension time as described herein is one example of a second frequency according to the present invention. Moreover, the CPU 16a executing the automatic deletion task to delete such user information is one example of a deletion device according to the present invention.

Since the fifth embodiment is based on the configuration of the second embodiment as described above, a user icon 144a, 264a corresponding to the non-use user is also displayed in gray in the fifth embodiment. That is, the user icon 144a, 264a corresponding to the non-use user is displayed in a form different from those of the other user icons 144, 264.

Note that the fifth embodiment is not necessarily based on the configuration of the second embodiment. In this case, the user icon 144a, 264a corresponding to the non-use user is not displayed in gray, but is displayed in the form similar to those of the other user icons 144, 264. Meanwhile, the user information on the user not logging in for the further predetermined extension period among the non-use users is automatically deleted as described above.

Moreover, the fifth embodiment may be based on the above-described configuration of the third embodiment. In this case, before deletion of the user information, the non-use user is notified that such a user corresponds to the non-use user, and specifically, the above-described notification mail is sent. Thus, the non-use user having received the notification mail logs in a multifunction machine 10 again before the user information on the non-use user oneself is automatically deleted, for example. In this manner, automatic deletion of such user information can be avoided. Moreover, the non-use user having received the notification mail can voluntarily delete the user information on the non-use user oneself before such user information is deleted.

Further, the fifth embodiment may be based on the above-described configuration of the fourth embodiment. In this case, before the user information on the non-use user having received the above-described notification mail is automatically deleted, such a non-use user merely replies to the notification mail so that automatic deletion of such user information can be avoided, for example.

### Application Example

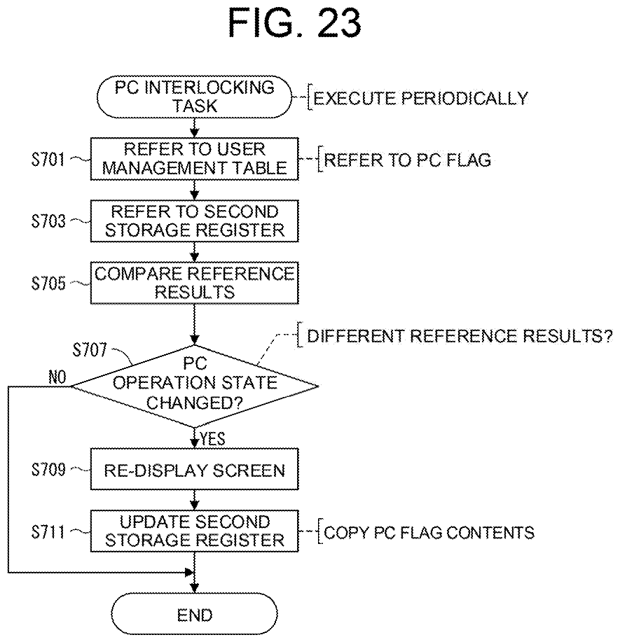

Next, an application example of the present invention will be described with reference to FIG. 23.

The present application example is, for example, based on the configuration of the first embodiment, and specifically, is based on the configuration in which the multifunction machine 10 and one or more PCs 30 are connected to each other via the network 50 as illustrated in FIG. 2. Specifically, in the present application example, only the user icon 144 corresponding to the PC 30 in an operating state (an activated state) is displayed (in other words, becomes active) on the above-described quick login screen 100, and the other user icons 144 are not displayed. Similarly on the user add/edit screen 200, only the user icon 264 corresponding to the PC 30 in the operating state is displayed, and the other user icons 264 are not displayed. Thus, the user information corresponding to the unoperated PC 30, specifically the user information on the absent user, cannot be edited, including deletion. Thus, unintentional editing of such user information can be prevented. This also greatly contributes to proper management of the registered user information.

In the present application example, although not illustrated in the figure, a PC confirmation program and a PC interlocking program are added as the above-described control program in addition to the configuration of the first embodiment. In addition, an internet protocol (IP) address as identification information for identifying the PC 30 owned by each user and a so-called PC flag indicating whether or not the PC 30 is in the operating state are added as the user information recorded in the user management table 400. Further, of the user information recorded in the user management table 400, the contents of the PC flag for each user (the PC 30), in a precise sense the contents of the PC flag at a certain time point, are directly copied in a second storage register as a second temporary storage section. Such a second storage register is, for example, provided in the above-described rewritable non-volatile memory forming the storage 16b.

Thereafter, the CPU 16a executes a PC confirmation task according to the above-described PC confirmation program. Although not illustrated in the figure, according to such a PC confirmation task, the CPU 16a confirms, by polling, whether or not each PC 30 is in the operating state, for example. Then, based on such a confirmation result, the CPU 16a updates the recording contents of the user management table 400, and specifically sets the PC flag for each user (each PC 30). For example, a value of “1” is recorded for the PC flag for the PC 30 in the operating state, and a value of “0” is set for the PC flag for the unoperated PC 30. Thereafter, the CPU 16a ends the PC confirmation task. Such a PC confirmation task is executed periodically, and for example, is repeatedly at a relatively-short time interval of several seconds to several minutes. Note that the CPU 16a executing such a PC execution task is one example of a confirmation device according to the present invention.

In parallel with such a PC confirmation task, the CPU 16a executes a PC interlocking task according to the above-described PC interlocking program. FIG. 23 illustrates the flow of such a PC interlocking task. As in the PC confirmation task, the CPU 16a periodically and repeatedly executes the PC interlocking task at a relatively-short time interval of several seconds to several minutes, for example. The CPU 16a executing such a PC interlocking task is one example of a second display control device according to the present invention.

According to such a PC interlocking task, the CPU 16a first refers to the user management table 400 at a step S701, and specifically refers to the PC flag for each user. Then, the CPU 16a proceeds the processing to a step S703.

At the step S703, the CPU 16a refers to the above-described second storage register. The contents of the PC flag are directly copied in the second storage register as described above, but a default value is stored at the point of time of first execution of the PC interlocking task, such as the point of time immediately after the multifunction machine 10 has been powered ON. A value of “0” is stored as the default value for each user. After execution of the step S703, the CPU 16a proceeds the processing to a step S705.

At the step S705, the CPU 16a compares a reference result of the user management table 400 at the step S701 and a reference result of the second storage register at the step S703. Thereafter, the CPU 16a proceeds the processing to a step S707.

At the step S707, the CPU 16a determines, based on a comparison result at the step S705, whether or not there is a change in the operating state of any PC 30. In other words, the CPU 16a determines whether or not the reference result of the user management table 400 at the step S701 and the reference result of the second storage register at the step S703 are different from each other. For example, in a case where there is no change in the operating state of each PC 30 (S707: NO), the CPU 16a ends the PC interlocking task as it is. On the other hand, in a case where there is a change in the operating state of any PC 30, i.e., any PC 30 is newly activated or any PC 30 which has been in the operating state is no longer in the operating state (S707: YES), the CPU 16a proceeds the processing to a step S709.

At the step S709, the CPU 16a re-displays the currently-displayed screen based on the recording contents of the user management table 400. Thus, in a case where the quick login screen 100 is, for example, being displayed, the user icon 144 corresponding to the newly-activated PC 30 is displayed, or display of the user icon 144 corresponding to the PC 30 which is no longer in the operating state is canceled. Moreover, as in a case where the user add/edit screen 200 is being displayed, the user icon 264 corresponding to the newly-activated PC 30 is displayed, or display of the user icon 264 corresponding to the PC 30 which is no longer in the operating state is canceled. Then, the CPU 16a proceeds the processing to a step S711.

At the step S711, the CPU 16a directly copies the contents of the PC flag recorded in the user management table 400 in the second storage register. That is, the CPU 16a updates the storage contents of the second storage register. After execution of the step S711, the CPU 16a ends the PC interlocking task.

As described above, according to the present application example, on, for example, the quick login screen 100, only the user icon 144 corresponding to the PC 30 in the operating state is displayed, and the other user icons 144 are not displayed. Similarly on the user add/edit screen 200, only the user icon 264 corresponding to the PC 30 in the operating state is displayed, and the other user icons 264 are not displayed. Thus, unintentional editing of the user information on the absent user can be specifically prevented. This also greatly contributes to proper management of the registered user information.

Note that in the present application example, the user icon 144, 264 corresponding to the unoperated PC 30 is not displayed, but the present invention is not limited to above. For example, the user icon 144, 264 corresponding to the unoperated PC 30 may be displayed in the form of gray out not accepting operation.

Moreover, the present application example is based on the configuration of the first embodiment, but is not limited to above. The present application example may be based on any of the configurations of the second to fifth embodiments other than the first embodiment. Further, the present application example is not necessarily based on any of the configurations of the first to fifth embodiments, and may be implemented alone.

### Other Application Examples

Each of the above-described embodiments and application examples are specific examples of the present invention, and is not intended to limit the technical scope of the present invention. The present invention can be applied to other aspects than above.

For example, instead of the user icon 144, 264 as the operator, other forms of operator such as a button may be employed.

Moreover, the user information may be registered not by operation of the multifunction machine 10 itself but by operation of each PC 30. Editing including deletion of the user information may also be allowed by operation of each PC 30.

Further, in each of the embodiments and the application examples, the example where the present invention is applied to the multifunction machine 10 has been described, but the present invention is not limited to above. Needless to say, the present invention can be also applied to other information processing apparatuss than the multifunction machine 10.

### DESCRIPTION OF REFERENCE NUMERALS

10 multifunction machine
16 controller
16a central processing unit (CPU)
20 communicator
22 display device
22a display
24 operation device
24a touch panel
144, 264 user icon
100 quick login screen
200 user add/edit screen
254 action panel
254b delete button
500 user registration screen for editing
600 password entry screen

What is claimed is:

1. An information processing apparatus including a display device that displays, based on registered user information, an operator corresponding to each user and receiving authentication operation by the user, comprising:
a delete command receiving device that receives a delete command for deleting the user information corresponding to an optional operator; and
a deletion device that deletes the user information under a condition that is entry of a user password or a predetermined administrator password in a case where the user password is attached to the user information according to the delete command and deletes the user information without condition in a case where no user password is attached to the user information.

2. The information processing apparatus according to claim 1, wherein
attachment of the user password to the user information is optional.

3. The information processing apparatus according to claim 1, further comprising:
a display control device that controls a display form of each operator according to a frequency of use of the information processing apparatus by each user.

4. An information processing apparatus including a display device that displays, based on registered user information, an operator corresponding to each user and receiving authentication operation by the user, comprising:
a display control device that controls a display form of each operator according to a frequency of use of the information processing apparatus by each user.

5. The information processing apparatus according to claim 3, further comprising:
a communication device that performs communication with each user-side user device; and
a notification device that sends predetermined notification information to the user device for any user via the communication device when the frequency of use by the user falls below a predetermined first frequency.

6. The information processing apparatus according to claim 5, further comprising:
a frequency changing device that takes the frequency of use by the user of the user device as not falling below the first frequency when response information for the notification information is received from the user device as a destination of the notification information via the notification device.

7. The information processing apparatus according to claim 5, further comprising:
a deletion device that deletes the user information on any user when the frequency of use by the user falls below a second frequency lower than the first frequency.

8. The information processing apparatus according to claim 3, wherein
the frequency of use by each user includes a length of a period in which a state in which the information processing apparatus is not used by the user is continued.

9. The information processing apparatus according to claim 1, wherein
the user information is optionally registrable.

10. The information processing apparatus according to claim 1, wherein
the information processing apparatus is a multifunction machine.

11. A computer-readable storage medium for storing a user management program in an information processing apparatus including a display device that displays, based on registered user information, an operator corresponding to each user and receiving authentication operation by the user, wherein
the user management program causes a computer of the information processing apparatus to execute
receiving a delete command for deleting the user information corresponding to an optional operator, and
deleting the user information under a condition which is entry of a user password or a predetermined administrator password in a case where the user password is attached to the user information according to the delete command and deleting the user information without condition in a case where no user password is attached to the user information.

12. A computer-readable storage medium for storing a user management program in an information processing apparatus including a display device that displays, based on registered user information, an operator corresponding to each user and receiving authentication operation by the user, wherein
the user management program causes a computer of the information processing apparatus to execute
controlling a display form of each operator according to a frequency of use of the information processing apparatus by each user.

13. A user management method in an information processing apparatus including a display device that displays, based on registered user information, an operator corresponding to each user and receiving authentication operation by the user, comprising:
receiving a delete command for deleting the user information corresponding to an optional operator; and
deleting the user information under a condition which is entry of a user password or a predetermined administrator password in a case where the user password is attached to the user information according to the delete command and deleting the user information without condition in a case where no user password is attached to the user information.

14. A user management method in an information processing apparatus including a display device that displays, based on registered user information, an operator corresponding to each user and receiving authentication operation by the user, comprising:
controlling a display form of each operator according to a frequency of use of the information processing apparatus by each user.
